(19) United States
(12) Patent Application Publication
(10) Pub. No.: US 2006/0006820 A1
(43) Pub. Date: Jan. 12, 2006

(54) Horticultural lighting system

(76) Inventors: Douglas Lee Roseman, Willits, CA (US); Noah Greenfield Mervine, Ukiah, CA (US)

Correspondence Address: Douglas Roseman, 2198 Poppy Lane, Willits, CA, 95490, US

(21) Appl. No.: 10/885,539

(22) Filed: Jul. 7, 2004

(51) Int. Cl. H05B 37/00

(52) U.S. Cl. 315/312

(57) ABSTRACT

A versatile yet highly specialized lighting system comprising a light source that emits specific and specialized light spectra and is adjustable through the use of a control interface, which is able to support plants form seedling to mature flowering and fruiting adults. The lighting system utilizes a power source to energize a lighting fixture. A given lighting fixture includes high efficiency luminary devices that may have varying color combinations and spatial arrangements. A substrate provides support and thermal management. Electrical connectors allow multiple lighting fixtures to be connected to a single power source. A switching device allows linear control of intensity, time and color parameters of the emitted light, and is programmable to simulate photoperiods and spectrum shift. The system is optimized to stimulate growth in plants during times of different light-intensity and light-spectrum needs. The design of the present invention takes into consideration various factors so the claimed lighting system operates at the highest possible efficiency and exhibits the longest possible life.

### CROSS-REFERENCE TO RELATED APPLICATIONS

Patents

U.S. Pat. No. 6,554,450 Apr. 29, 2003 Fang et al. “ARTIFICIAL LIGHTING APPARATUS FOR YOUNG PLANTS USING LIGHT EMITTING DIODES AS A LIGHT SOURCE”
U.S. 20010047618A1 Dec. 6, 2001 Fang, Wei; et al.

### OTHER REFERENCES

1. “Gardening Indoors” Van Patten; Van Patten Publishing; 2002.
2. “Botany, An Introduction to Plant Biology” 5^{th} ed.; T. Elliot Weier; U C Davis; 1950-1974.
3. “Plant Lighting Systems” Dr. W. M. Knott, Dr. R. M. Wheeler; NASA; 1998-2001.
4. “Development of Plant Growth Apparatus Using Blue and Red LED as Artificial Light Source” K. Okamoto, T. Yanagi, M. Tanaka, T. Higuchi, Y. Ushida, H. Watanabe; Kagawa University, Ryusho Industrial Co., Mitsubishi Chemical Corp.; 1996
5. “WSCAR Will Grow Seed-To-Seed Wheat Plants Aboard Mir . . . ” The Board of Regents; University of Wisconsin System; 1998-2002.
   Internet Sources
1. http://users.rcn.com/jkimball.ma.ultranet/BiologyPages/L/LightReactions.html; “Photosynthesis: The Role of Light;”
2. http://photoscience.1a.asu.edu/photosynthesis/photointro.html; “An Introduction to Photosynthesis and its Applications” Wim Vermaas; Arizona State University; 1998.
3. http://spot.colorado.edu/˜basey/green.htm; “Rate of Photosynthesis of Green and Yellow Leaves Under Green Light;” Rebecca Marcelliano, T. Dean Nelson, Joshua Prok, Ryan Mills, Kassi Neff;
4. http://www.actahort.org/books/22/22_{—}16.htm; “Light Sources for Promoting Photosynthesis” I. J. Cooke, A. N. Burdett, S. F. Morgan.
5. http://149.152.32.5/Plant_Physiology/photoperiodisml.html; “Photoperiodism”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to a lighting system, which is highly efficient, reliable and versatile, yet specifically developed as an artificial plant-growth light.

Current fluorescent and gas discharge lights operate at relatively low conversion efficiency usually below twenty percent, emit excess light spectra, and lack longevity leaving room for improvement.

Until recently, Light Emitting Diodes (LEDs) have been manufactured and sold as “super bright” and typically consume 20 to 50 miliamps. These second generation LEDs have now been superceded by third generation devices consuming over 200 miliamps, which require thermal management means. It is a common misconception that LEDs emit no heat; with third generation LEDs, the amount of heat LEDs do emit becomes obvious. Therefore, thermal management and efficiency are important factors in the high-power LED lamp design claimed herein.

With LEDs comes the possibility of strongly monochromatic light and chroma-specific lighting fixtures. Photosynthetic plants make use of specific wavelengths i.e. colors of light as their energy source and for various types of stimulation. The wavelength requirements of the plants are determined by the specific light receptors and physiological needs present in the plants.

Until the advent of high-output third generation LEDs, LED plant-growth systems were unusable and unaffordable for anything more than tiny seedlings, and were not practical due to the large number of second gen. LED units required. Usage of third gen. LEDs eliminates these problems.

Daily on-off cycling typical in growing applications causes undue stress and premature failure of the gas-discharge lights. Never before has it been possible to achieve the longevity of a lighting fixture as with LEDs.

Commercial horticultural lighting systems currently available almost exclusively utilize gas-discharge technology. Some such fixtures include the following:
1. Fluorescent is a specific type of gas-discharge lighting technology. Firstly, utilizing a combination of chemical elements as the phosphor (light-emitting substance), some fluorescent bulbs are designed to produce horticulturally-specific output, i.e. red and blue, but the phosphors used result in a great proportion of spectra of which the plant utilizes only a small amount resulting in marginal performance. Secondly, these bulbs also typically utilize a heated filament, which is under stress and is frequently a cause of failure. Thirdly, fluorescent bulbs utilize mercury as the exciter element, which is toxic and escapes when the bulb eventually breaks.
2. High Intensity Discharge (HID) varieties operate under plasmatic conditions and are therefore inherently short-lived. These bulbs emit relatively intense infrared radiation and are known to cause damage to plant and animal tissue if precautions are not taken. Examples of HID lighting technologies include the following:
   High Pressure Sodium (HPS): The spectra emitted from this type of light contain a proportion of some of the red light required for plant growth, but lack especially in the blue spectra resulting in abnormally slow-growing plants. In the event that the outer glass envelope breaks, HPS lamps emit hazardous levels of ultraviolet (UV) light.
   Halide and Mercury Vapor: These bulbs partially solve the problem of lack of blue light, but also emit high proportions of green and yellow light resulting in a very white-appearing light, much of which is wasted as it is only utilized in small amounts by the plant.
   “Combination”: Some horticultural fixtures utilize a combination of sodium and halide bulbs in attempt to meet both the red and blue light needs. While this is a sound concept, precise spectrum matching and longevity are limited.
   “Conversion”: A bulb with known spectral qualities, which may be used to replace a given HPS, halide or mercury bulb, is known as conversion bulb.

The only patent known to us indicating the use of LEDs for plant growth is U.S. Pat. No. 6,554,450 issued to Fang. Fang indicates use of blue light of 450 nm and red light of 660 nm. We find that this particular strongly dichromatic spectrum promotes phototropism to such a degree that many plants over-extend themselves, we utilize wavelengths in addition to the suggested 450 nanometers and 660 nanometers. Through our experiments with LED grow lights of various colors, we find that no plants do as well as the plants supplemented with green light. Fang further utilizes second gen. LEDs assembled on circuit boards and small growth chamber which is limited for tiny seedlings.

Other patents have described using LEDs for general lighting purposes. See for example U.S. Pat. No. 6,603,271B2 indicating red, green, blue and white luminary elements.

LEDs are very sensitive to excessive current. Typical commercially-available LED lamps utilize resistors as the current-limiting devices, which are non-regulating resulting in inconsistent light output and premature failure, and are inherently wasteful resulting in excessive heat dissipation and power consumption.

High efficiency and longevity are generally sacrificed due to the high cost of impedance-matching supplies vs. the cost of a second gen. LED's.

Usage of second gen. LEDs is materially inefficient due to the light-output capability in comparison to the total mass of the device.

Other systems, as described in a NASA bulletin entitled “Plant Lighting Systems” are elaborate devices indicated for highly experimental use for culturing young seedlings in orbit, and are unavailable to the public. These lighting systems still encounter limited light volume capability, which prohibits growing anything bigger than tiny young plants.

### BRIEF SUMMARY OF THE INVENTION

It is therefore a general objective of this invention to provide a versatile and adaptable lighting system utilizing high efficiency luminary elements mounted on a substrate providing heat and physical stress management. A universal impedance-matching power supply, time-variable and color-intensity-variable spectral adjustments and electrical connection means are used.

A further objective is durability and high lumen maintenance, which are native features of LEDs and are far superior to any of the glass-based luminary elements currently available.

A primary objective of the invention is photosynthesis resulting in plant growth, i.e. the conversion of light into usable energy. This particular objective is attained as a byproduct of some of the other types of stimulation due to the wavelengths involved and wavelength specificity required by such stimulation as compared to that required for photosynthesis.

It is widely accepted that the action spectrum for photosynthesis in most plants is strongly dichromatic light with major peaks close to blue 435 nm and red 670 nm. Note that photosynthesis does not necessarily equate to growth.

Another general objective of the present invention is to provide spectra that will optimize growth rate considering the competing functions of plant strength vs. size in addition to other factors.

An additional objective of the present invention is phototropic stimulation. Phototropism is the phenomenon of structural adjustment response in plants due to changing light conditions. We consider the spectral response peaks for phototropism to be blue 445 nm and red 645 nm.

Yet another objective of this invention is photoperiodistic control. Photoperiodism is a well-know phenomenon observed in nature and known to signal to plants the current season. According to “Gardening Indoors” a shift in natural light spectra stimulate specific hormones in plans. Spectral control further increases the effectiveness and versatility of the horticultural lighting system claimed herein.

An advanced objective of the present invention is phytochrome stimulation. Phytochrome is a physiologically active pigment that regulates growth, and absorbs deep red light near 670 nm to 680 nm in the “Pr” form and 720 nm to 730 nm in the “Pfr” form.

A specialized objective of this invention is cryptochrome stimulation. Cryptochrome is so named for its mysterious presence evading identification for many years, though it is indirectly apparent for plant growth. It is a pigment known to absorb large amounts of light in the 290 nm and 320 nm to 380 nm in color.

A preferred embodiment utilizes luminaries operating near the aforementioned wavelengths.

Usage of LEDs with relatively coherent output virtually eliminates burns due to minimized infrared emissions allowing operation closer to plants than in prior art, and therefore more effectiveness, resulting in high yield with relatively small energy expenditure.

This invention describes a light fixture in which luminary elements are chosen carefully in order to achieve the desired spectral distribution so the maximum possible energy transfer is attained. The growth stage, plant type, quality of growth required and other specific circumstances determine the exact configuration of the lighting system.

A preferred embodiment of the present invention allows optimization of the lighting system for photosynthesis, phototropism, and photoperiodism for a variety of plant types in addition to other more broad applications. Each emitted light wavelength is independently adjustable and programmable in brightness and time.

Yet another feature of a the preferred embodiment is true current regulation using a switching regulator featuring impedance matching and good thermal management using heat conductive means to maximize efficiency and life expectancy of the system.

Simplicity of design is maximized by electrical connection schemes that use one current regulator for a plurality of luminary devices.

New third gen. LEDs are relatively high energy devices compared with still-popular second gen. LEDs producing greater light and proportionally more heat output and therefore require special consideration of heat dissipation means.

Usage of higher output third gen. devices also means less material overhead and therefore better environmental responsibility and lower manufacturing cost.

Expandability of the lighting system is accomplished by mounting additional power connectors on the fixture or the master unit allowing fixtures to be added to an existing system without additional power supplies.

Trough extensive experimentation, we have determined the optimum luminary elements to achieve the highest possible efficacy with respect to light creation, light utilization, financial practicality, and material responsibility.

Further advantages will become apparent upon study of the drawings.

### BRIEF DESCRIPTION OF THE SEVERAL VIEWS OF THE DRAWINGS

To better understand the proposed lighting system, several diagrams are included:

FIG. 1 is a perspective view of the entire invention showing the horticultural lighting system.

FIG. 2 is a perspective view of the master unit showing the power cord and user interface.

FIG. 3 is a perspective view of the fixture illustrating one possible arrangement of the luminary elements.

FIG. 4 is a side view of the preferred disconnectable connection.

FIG. 5 is a diagramatic view of the invention.

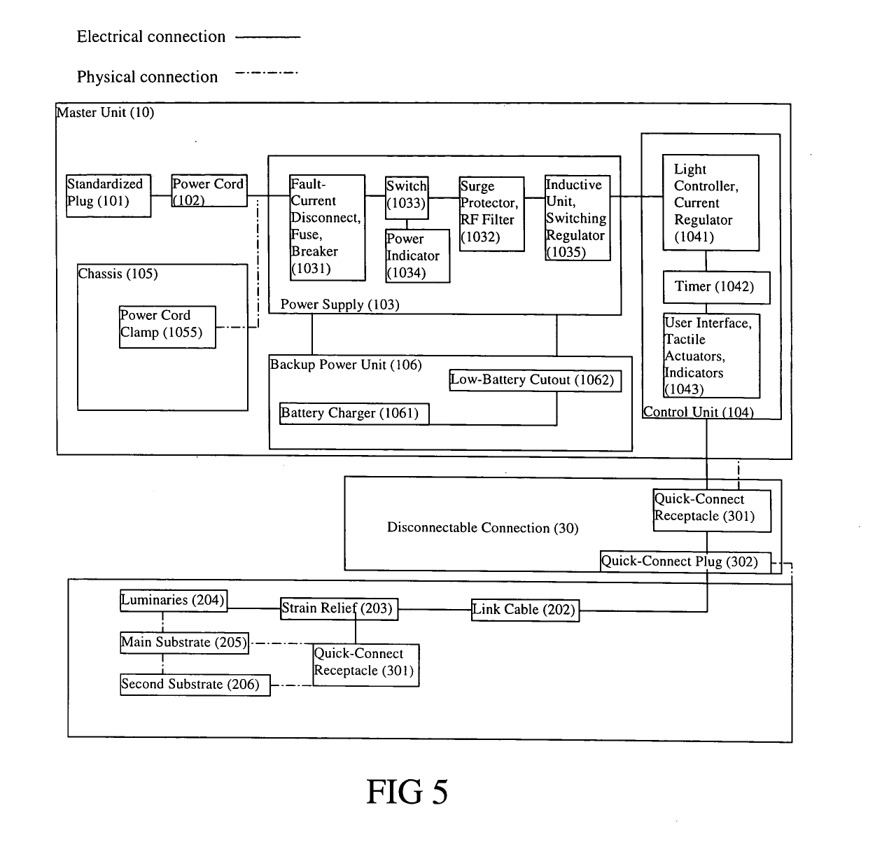

### DETAILED DESCRIPTION OF THE INVENTION

As will become evident by further study of the drawings, the present invention relates to a versatile lighting system especially for plant-growth illumination.

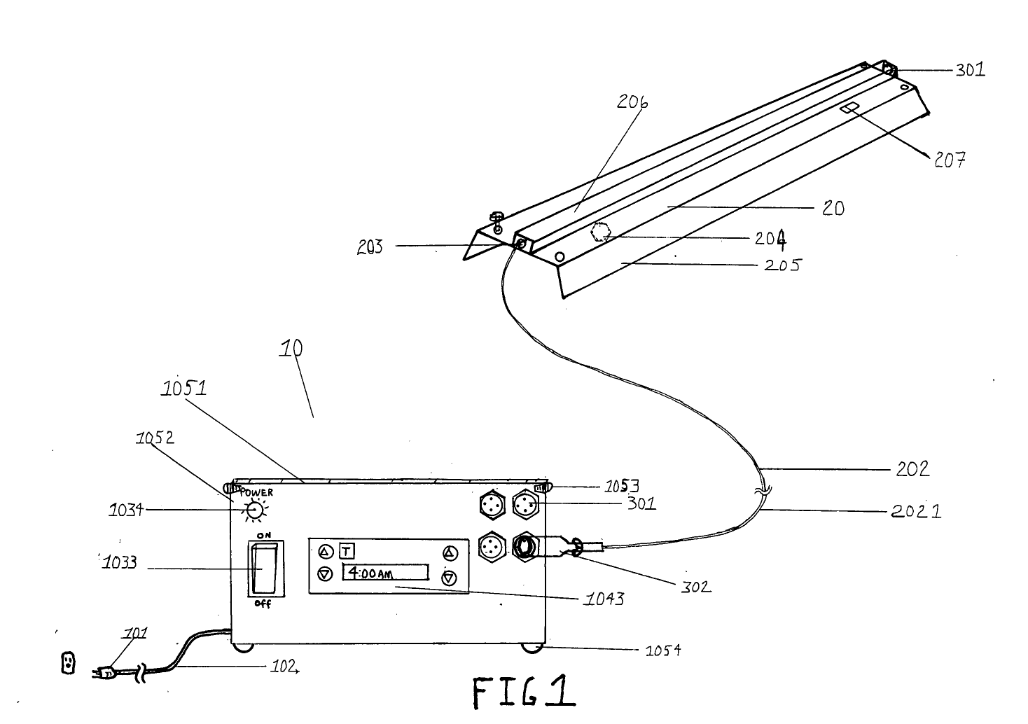

According to the preferred embodiment of the present invention, FIG. 1 of the drawings shows the horticultural lighting system comprising a master unit 10 and fixture 20. The master unit 10 includes a standardized plug 101 affixed to the end of a power cord 102 and attached to a chassis 105.

The chassis 105 comprises a lid 1051, a main housing 1052, fastening screws 1053, rubber feet 1054 and a power cord clamp or gland 1055. The chassis 105 houses a power supply 103 which includes a fuse 1031, a surge protector 1032, a switch 1033, a power indicator 1034 and an inductive unit 1035. The chassis 105 also houses a control unit 104 which includes a light controller 1041, a timer 1042 and a user interface 1043. In a preferred embodiment, a backup power unit 106 interfaces with the power supply 103. The backup power unit 106 may include a battery (not shown) which helps to insure continuous operation during times lacking main power source, and further conditions the power source.

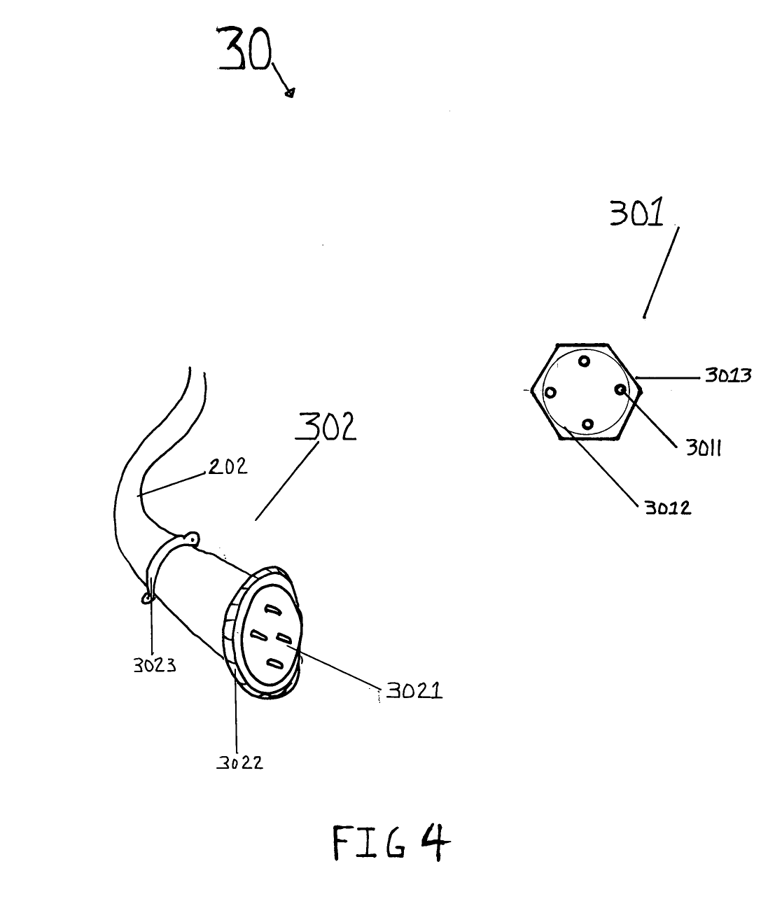

As shown in FIG. 4, a disconnectable connection 30 includes a quick-connect receptacle or output receptacle 301 and a quick-connect plug or input plug 302.

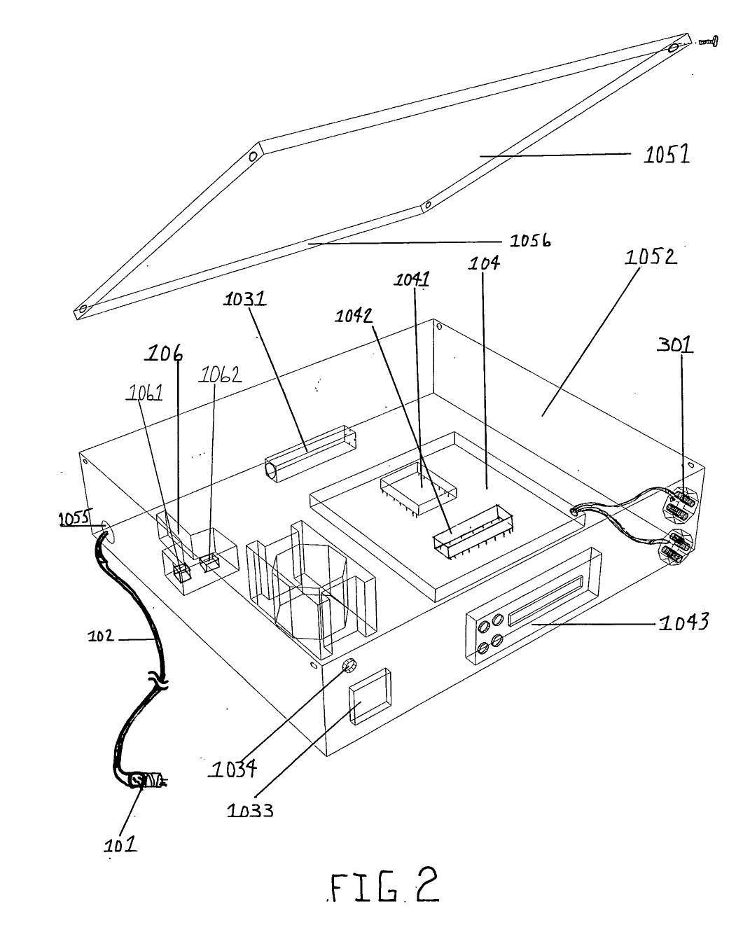

The Power cord 102 is made of insulated flexible electrical wire, which is impervious to water to ensure adequate protection while conducting power to the master unit 10, and is equipped with a standardized plug 101 able to be plugged into a standardized outlet (not shown). As shown in FIG. 2, the gland 1055 is mounted in the wire point-of-entry on the main housing 1052 and provides adequate support and moisture protection where the electrical-supply power cord 102 enters the chassis 105.

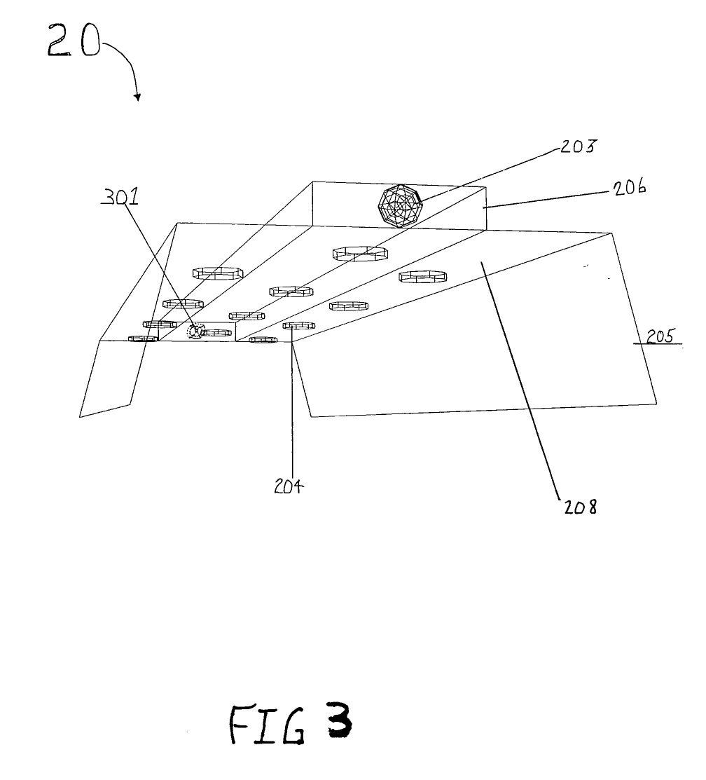

Referring to FIG. 3, the chassis 105, being made of any number of materials including poly-vinyl-chloride (PVC), poly-styrene (PS), poly-carbonate (sold under the trade name ‘Lexan’), aluminum or other durable material, includes a cover 1051 and a silicone seal or gasket 1056 whereby, when securing the cover 1051 to the housing 1052 with threaded screws 1053, the silicone seal 1056 is sandwiched between the cover 1051 and base 1052 providing a water-resistant barrier.

Upon entering the chassis 105 through the gland 1055, the power cord 102 connects to the power supply 103. The fault-current disconnect, fuse or circuit breaker 1031 provides protection in an event of a device failure, for example, if one of the diodes of a bridge rectifier “blows short” causing a diode to be forward biased with the power source and a high current to pass.

After passing through the fault-current disconnect 1031, power is then routed through a sealed, manually-operated on-off power switch 1033, which features moisture protection and gates power to the surge protector 1032. After passing through the surge protector 1032, which virtually eliminates transients including radio frequency (RF) noise and spikes present on the power source, power is then routed to inductive unit 1035. In an alternate embodiment, the inductive unit 1035 includes a solid-state switching regulator circuit, which affects an AC voltage to the inductive element (not shown) to achieve impedance matching and therefore power efficiency, especially in cases where only DC power is available.

The inductive unit 1035 utilizes an inductive element to exchange voltage for current or current for voltage, i.e. to conserve power, in effect acting to match the impedance of the power source with that of the luminaries 204. A light controller or current regulator 1041 further regulates the power to a drive current suitable for LEDs.

Power is further routed to a control unit 104, which adjusts the lighting output. Through a user interface 1043, the user programs the control unit 104, which then uses the entered information to illuminate an appropriate luminary group to an appropriate intensity. In one possible embodiment, the program may consist of a single switch, which is either on or off, affecting the same condition in a luminary group. In an alternate embodiment, brightness of several different groups may be linearly and independently adjusted through the setting of a tactile actuator 1043. In yet another embodiment, the color-intensities at specified time may be programmed using the tactile actuator 1043 so that the color output of the fixture 20 corresponds to the programmed setting. The appropriate spectrum simulates the time of day or time of season; the appropriate photoperiod is likewise programmable.

The output receptacle 301 is fixably mounted to the chassis 105, receives power from the control unit 104 and facilitates multiple inputs 302 from fixtures 20. A fixture 20 includes an input plug 302 affixed to the end of the link cable 202, which electrically couples to the master unit 10. FIG. 1 further shows the fixture 20 with the input plug 302, the link cable 202, the strain relief 203, the luminary elements 204, the main substrate 205 and second substrate 206.

In the preferred embodiment, as shown in FIG. 4, each quick connect receptacle 301 includes a plurality of female pin receptacles 3011, a threaded barrel 3012 and a threaded mounting nut 3013. The link cable 202 is fitted with a screw-type quick-connect plug 302 including a plurality of electrical contact pins 3021, a retainer nut 3022 and a strain-relief clamp 3023.

The quick connects 301 and 302 provide an adequate watertight barrier as well as a secure mechanical and electrical connection. Each quick connect receptacle 301 can receives any one of the quick connect plugs 302 of a given light fixtures 20. Thus, a plurality of fixtures 20 may be plugged into and operated using a single master unit 10, avoiding the need for a dedicated master unit 10 for each lighting fixture 20, as is typically required with conventional plant lighting systems, improving system versatility.

According to the preferred embodiment, the main substrate 205 comprises a section of heavy-gauge cast aluminum to provide maximum support, heat dissipation, light direction, and imperviousness to moisture. The lighting fixture 20 of the present invention includes a plurality of luminary elements 204 affixed to the main substrate 205 in a manner which provides maximum lighting effectiveness by spreading the illumination over a relatively wide area while dissipating heat to ensure the luminaries 204 operate at minimal operating temperature which extends system life and efficiency.

As shown in FIG. 1, a link cable 202 conducts power from the master unit 10 to the light fixture 20. The link cable 202, in the preferred embodiment, is thinner than the power cord 102 for ease of movement of the fixture and is less cumbersome so as not to damage plants. A wide verity of conventional cables could be used for the link cable 202 provided the conductors are finely stranded bundles and the outer jacket 2021 is a resilient water-tight insulation to ensure long life of the cable 202 as well as to ensure a safe means of electrical power transmission to the light fixture 20. As depicted in FIG. 1, the link cable 202 is secured to the light fixture 20 through a strain relief 203, which is attached to the main substrate 205.

Hookup wires (not shown) provide an electrical path from the strain relief 203 through holes (not shown) in the main substrate 205 to the luminaries 204.

The luminaries 204, in the preferred embodiment, are electrically connected in groups in series to facilitate current regulation.

We claim:

1) A horticultural lighting system comprised of:
A master unit further comprising:
A chassis comprising a sturdy enclosure whereby all electrical components are adequately protected; and
A power cord comprising suitable conductive, insulative and tensile members; and
A power supply.
A fixture further comprising:
A main substrate.
At least one luminary group comprising one to a plurality of luminaries.
A link cable comprising a plurality of electrically-conductive bundles providing electrical connectivity between said master unit and said fixture.

2) The system as claimed in claim 1 further including a disconnectable connection means comprised of:
A quick connect plug further comprising:
a suitable electrically-insulative structure mechanically bonded to said link cable whereby said link cable operates in a structurally-sound fashion; and
a set of electrically conductive pins each electrically bonded to each of said bundles respectively.
A complementary quick connect receptacle further comprising:
a similar electrically insulative material and electrically conductive receptacles structurally complementary in nature needs electrically and mechanically bonded to said master unit.
whereby said plug plugs into said complementary receptacle and therefore said fixture derives power from said master unit.

3) The system as claimed in claim 1 further including at least one additional receptacle whereby a plurality of fixtures may derive power from the electronic device.

4) The link cable as claimed in claim 1 comprising a duplicity of conductors whereby current will continue to flow and the luminary elements continue to emit light in spite of a hypothetical failure of a given current path, and therefore operation is made more reliable.

5) The disconnectable connection means as claimed in claim 2 further including a water-impermeable seal and a locking mechanism whereby dust, water and other contaminants are adequately repelled and electrical connection is insured.

6) The fixture as claimed in claim 1 wherein said substrate comprises a section of material being of heat diffusive and physically supportive properties whereon said luminary group is mounted and operates at a temperature essentially the same as the surrounding air whereby operational efficiency and life-span are maximized.

7) The fixture as claimed in claim 1 further including a strain relief means comprising a physical support affixed to said substrate and serving to clamp said link cable to said substrate whereby physical strain originating from said link cable is transferred to said substrate and isolated from said luminary elements.

9) The fixture as claimed in claim 1 further including second substrate fixably mounted to said main substrate forming a protective zone using a suitable fastener whereby hookup wires which connect to said luminary group are protected from damaging elemental forces.

10) The fixture as claimed in claim 1 further including secondary electronic components whereby current through said luminary is limited to an acceptable level.

11) The fixture as claimed in claim 1 further including a current bypass means comprising solid state components connected in avalanche fashion making electrical connections on the respective upstream and downstream sides of a given luminary group whereby, in the event of a hypothetical failure of a luminary group, any other luminary group may operate through said bypass in spite of the hypothetical failure in conjunction with a the series connection of the hypothetically-failed luminary group with the other luminary groups.

12) The fixture as claimed in claim 1 wherein groups of luminary elements comprise series-connected luminaries whereby current regulation in many luminaries is accomplished using a single current regulator.

13) The fixture as claimed in claim 1 further including a polymer-coating impervious to a liquid whereby said lighting fixture may be operated normally while submerged in said liquid, further that said link cable is similarly impervious to said liquid.

14) The luminary group as claimed in claim 1 wherein a given luminary element is a light emitting diode (LED) whereby maximum efficiency, life span and durability are attained.

15) The luminary group as claimed in claim 1 wherein
said luminary group comprise two subgroups of devices wherein a first subgroup is rated to emit dominant wavelengths 400 to 500 nanometers and a second subgroup is rated to emit dominant wavelengths about 620 to 690 nanometers
whereby basic plant growth lighting needs are met.

16) The luminary group as claimed in claim 1 wherein
a majority of luminary elements comprise two subgroups of devices wherein a first subgroup is rated to emit dominant wavelengths about 400 to 500 nanometers and a second subgroup is rated to emit dominant wavelengths of about 630 to 690 nanometers; and
a minority of luminary elements comprise two subgroups of devices wherein a subgroup is rated to emit dominant wavelengths about 510 to 560 nanometers and another subgroup is rated to emit dominant wavelengths about 590 to 630 nanometers
whereby photosynthesis, phototropism, chlorophyll synthesis are enhanced and trace light requirements are met and desired growth is further enhanced.

17) The luminary group as claimed in claim 1 wherein
a majority of luminary elements comprise two subgroups of devices wherein a first subgroup is rated to emit dominant wavelengths from 350 to 480 nanometers and a second subgroup is rated to emit dominant wavelengths about 630 to 690 nanometers whereby photosynthesis, phototropism, fruiting and flowering may be selectively controlled; and
a first minority of devices comprise two luminary subgroups wherein a subgroup is rated to emit dominant wavelengths between 510 to 560 nanometers and another subgroup is rated to emit dominant wavelengths between 610 to 630 nanometers whereby the trace light requirements for photosynthesis are met; and
a second minority of devices comprising a luminary subgroup rated to emit dominant wavelengths between 705 to 745 nanometers whereby the phytochrome reversion reaction may be selectively accelerated; and
a third minority of devices comprising a luminary subgroup rated to emit dominant wavelengths near 290 and 320 to 380 nanometers whereby cryptochrome is stimulated to a great extent.

18) The link cable as claimed in claim 1 comprising
a flexible and insulative layer independently encapsulating each of said conductive bundles; and
a resilient outer jacket whereby the electrical integrity of said insulative members and said conductive members is insured.

19) The master unit as claimed in claim 1 further including an impedance-matching power supply means comprising at least one inductive element wherein an alternating voltage is used to match the impedance of the power source with the impedance of the luminaries whereby power is conserved allowing maximum possible overall efficiency.

20) The master unit as claimed in claim 1 further including an external means to set the specific output of a given light wavelength comprising at least one manually-actuated device mechanically coupled to a variable electronic element and mounted in the front panel of said electronic device, whereby the spectral output from said fixture may be manually controlled.

21) The master unit as claimed in claim 1 further including a timer circuit to energize and de-energize luminary groups at specified times.

22) The master unit as claimed in claim 1 further including brightness control by which intensity of each color output may be programmed whereby the growing seasons may be simulated and maximum yield produced.

23) The master unit as claimed in claim 20 further including a solid state microcontroller whereby said intensity and said times are programmable and preset programmed seasons may be included for fast and easy startup.

24) The master unit as claimed in claim 21 further including a means for-one touch nighttime operation comprising a manually-actuated electrical switch gating power to an green or amber-light-emitting luminary group whereby illuminated human interaction with plants during an ordinarily-dark period may occur without disturbing a photoperiodistic season.

25) The master unit as claimed in claim 1 further including a backup power unit comprising a battery charger, a low-battery cutout circuit and battery-interface hardware.

26) The power supply as claimed in claim 1 further including a fault-current disconnect, a power switch and a power indicator.

27) The power supply as claimed in claim 1 further including a switching regulator circuit which produces an oscillating power signal whereby the impedance-matching function may be utilized given a direct current source.
